(19) United States
(12) Patent Application Publication
(10) Pub. No.: US 2025/0154004 A1
(43) Pub. Date: May 15, 2025

(54) METHOD TO CONVERT NATURAL GAS AND CARBON DIOXIDE INTO HYDROGEN AND CARBON MONOXIDE USING A NI-AL2O3 CATALYST

(71) Applicant: Qatar Foundation for Education, Science and Community Development, Doha (QA)

(72) Inventors: Ma'moun Al-Rawashdeh, Doha (QA); Ahmed Mohamed Shehata Soliman, Doha (QA); Patrick Linke, Doha (QA)

(21) Appl. No.: 18/939,864

(22) Filed: Nov. 7, 2024

Related U.S. Application Data
(60) Provisional application No. 63/548,250, filed on Nov. 13, 2023.

(51) Int. Cl. C01B 3/40; B01J 21/04; B01J 23/755; B01J 35/30; B01J 35/45; B01J 35/61; B01J 37/02; B01J 37/08

(52) U.S. Cl. CPC C01B 3/40; B01J 21/04; B01J 23/755; B01J 35/393; B01J 35/394; B01J 35/45; B01J 35/613; B01J 35/615; B01J 37/0201; B01J 37/08; C01B 2203/0238; C01B 2203/1058; C01B 2203/1082; C01B 2203/1094; C01B 2203/1241

(57) ABSTRACT

A method for converting natural gas and carbon dioxide into hydrogen and carbon monoxide using a Ni—Al₂O₃ catalyst. In one embodiment, the method includes using a dual-mode cyclic reactor. Moreover, the disclosed technology relates to a catalyst, its preparation method, and the process of converting natural gas with carbon dioxide to hydrogen (H₂) and carbon monoxide (CO). The catalyst is used in a cyclic reactor system process that contains two modes of operation (Mode I and Mode II) and two different feeds (Feed A and Feed B), one per mode of operation. Feed A can be a methane, or methane-rich stream. Feed B is specified to be a carbon dioxide, or carbon dioxide-rich stream.

### RELATED APPLICATIONS

The present disclosure claims priority to U.S. Provisional Patent Application 63/548,250 having a filing date of Nov. 13, 2023, the entirety of which is incorporated herein.

### BACKGROUND

There are multiple commercial and mature technologies to convert natural gas into synthesis gas (hydrogen and carbon monoxide/carbon monoxide). These are Steam-Methane Reforming (SMR), Partial Oxidation of Methane (POX), and Autothermal Reforming (ATR). These technologies have major climate impacts as they produce rather than use carbon dioxide (CO₂). There is a pressing need to replace these technologies with lower carbon or negative carbon solutions. One promising approach to get hydrogen from natural gas with low to zero Carbon Dioxide (CO₂) emission is via methane decomposition or cracking reaction that produces hydrogen and solid carbon. Although many technology options are proposed for this reaction, very little or limited effort was made to further convert the generated carbon to another new intermediate product as carbon monoxide via gasification with CO₂. Specifically, there is a need to eliminate this CO₂ footprint and generate carbon credits. Relatedly, there is a need for the generation of wide ranges of CO/H₂ ranges that can work for a wide variety of downstream processes.

### SUMMARY

According to one non-limiting aspect of the present disclosure, an exemplary embodiment of a method to convert natural gas and carbon dioxide into hydrogen and carbon monoxide using a Ni—Al₂O₃ catalyst. In one embodiment, the method includes using a dual-mode cyclic reactor.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 is a schematic of a reactor system for converting natural gas with carbon dioxide (CO₂) to hydrogen (H₂) and carbon monoxide (CO), according to an example embodiment of the present disclosure.

FIG. 2 shows cracking and gasification cycle graphs, according to an example embodiment of the present disclosure.

FIG. 3 shows x-ray diffraction spectra graphs, according to an example embodiment of the present disclosure.

FIG. 4 shows H₂-TRP profiles of a 10% Ni/Al₂O₃ catalyst synthesized by impregnation and Solution Combustion Synthesis methods, according to an example embodiment of the present disclosure.

FIG. 5 shows Raman of spent catalyst samples for impregnation and Solution Combustion Synthesis, according to an example embodiment of the present disclosure.

### DETAILED DESCRIPTION

The present disclosure generally relates to a method to convert natural gas and carbon dioxide into hydrogen and carbon monoxide using a Ni—Al₂O₃ catalyst.

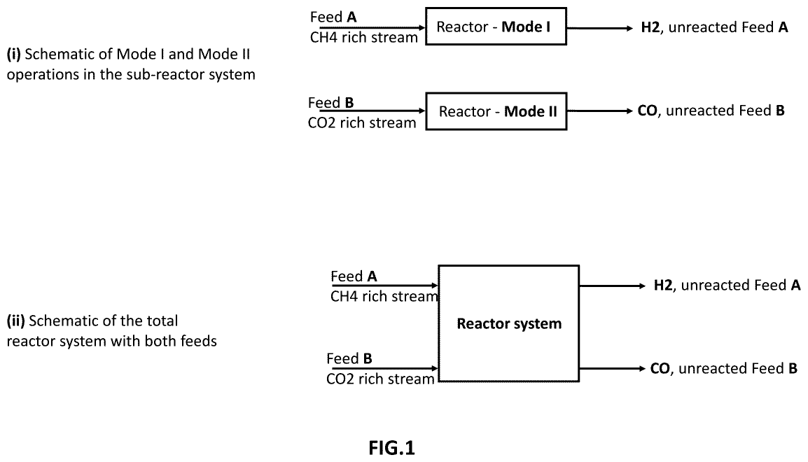

The disclosed technology proposes a catalyst, its preparation method, and the process of converting natural gas with carbon dioxide (CO₂) to hydrogen (H₂) and carbon monoxide (CO). The catalyst is used in a cyclic reactor system process that contains two modes of operation (Mode I and Mode II) and two different feeds (Feed A and Feed B), one per mode of operation (see FIG. 1). Feed A can be a methane, or methane-rich stream. Feed B is specified to be a carbon dioxide, or carbon dioxide-rich stream.

In operating Mode I (cracking), the reactor system receives Feed A, which is converted over the solid catalyst into two products: hydrogen and solid carbon, the latter is deposited on the catalyst. The effluent from the reactor system exit stream during operating Mode I contains hydrogen and unreacted Feed A (FIG. 1). In operating Mode II (gasification), a reactor zone receives Feed B that reacts with the solid carbon that was deposited on the solid catalyst during operating Mode I to form carbon monoxide (CO), carbon dioxide (CO₂), or a mixture thereof. The effluent from the reactor exit stream during operating Mode II contains carbon monoxide (CO), carbon dioxide (CO₂), and unreacted Feed B (FIG. 1).

The solid catalyst is the foundation for this process as it enables both reactions in Mode I (cracking) and Mode II (gasification). The ideal catalyst for this process needs to maintain long-term stability with no loss in activity and a high level of productivity over a long operation time with many repeated cycles. Catalyst stability over the many repeated cycles is an essential requirement for the success of this process. Catalyst productivity translates into maintaining the same level of conversion for Feed A as long as possible (longer time on stream) during Mode I, and a stable and repeatable complete conversion for Feed B during Mode II. In addition, the ideal catalyst needs to maintain similar operating conditions and similar time scales during both modes of operation. This requirement will simplify the reactor system design and operation as it will mostly translate into handling feed composition switching.

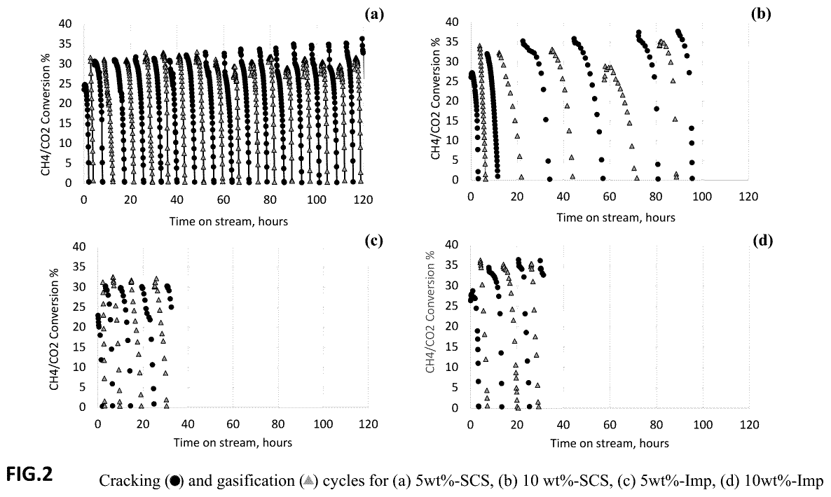

As such, the disclosed technology is based on a metal-supported catalyst that is Nickel (Ni) metal deposited on Alumina support (Al₂O₃) prepared via impregnation and via solution composition synthesis (SCS) technique. Although significant knowledge is available on supported metal catalysis (and on Ni—Al₂O₃) and preparation methods via SCS, the disclosed technology defines the combination and requirements to make this process successful. FIG. 2 shows an example of the exceptional long-term stability and productivity of the catalyst in the disclosed technology.

The catalyst has Ni nanoparticles on the catalyst in the range of 10 to 100 nm, alumina support that has SA in the range of 80 to 200 m2/g, and Ni content in the range of 1 to 25 wt %. The catalyst is prepared by the solution combustion synthesis method and or by impregnation method. Alumina support is impregnated with a solution that contains a Ni-precursor that can be dissolved in a solvent, and a combustion fuel. The SCS is carried out in a batch reactor triggered by temperature, the catalyst is collected and then is dried and calcined. The resulting catalyst has Ni-nano particles in the target size and distribution, and the strength of metal-support interaction is in the right window needed by both reactions in Mode I and Mode II. The support-metal interaction plays a significant role in the quality of the generated carbon needed for this process and the catalyst stability, and productivity. Impregnation method starts the same as SCS but without using any combustion fuel, catalyst is then dried and calcined following standard procedures as known in the art.

This disclosure provides various benefits and solutions to the aforementioned needs in the relevant field of art. First, the disclosed technology is CO₂ negative at the reaction stoichiometry level. CO₂ is used as a feedstock to convert the solid carbon formed at the catalyst in Mode I into carbon monoxide to make the catalyst available for a new cracking cycle. Second, the proposed catalyst has a very good long time on stream stability after many repeated cycles (FIG. 2). Moreover, the catalyst has very stable and high productivity to make H₂ and it can operate both Mode I and Mode II at similar operating conditions (550° to 650° C.) and time scales, thereby making the reactor and process simpler and more economical.

Additionally, the disclosed technology does not produce carbon as an end product, but it is considered as an intermediate to make CO, which is valuable feedstock for many industries. Pure H₂ and pure CO can be produced and used separately by different downstream plants, or to produce synthesis gas with a wide range of H₂/CO ratios that can be integrated with an existing syngas facility. This is important because synthesis gas is the starting point for the production of many bulk and platform chemicals including methanol, ammonia, and urea and, therefore, the disclosed technology has a wide range of applications in multi-billion dollar product markets. Relatedly, the disclosed technology can also enable solutions to decarbonize existing facilities by processing CO₂ emissions from these facilities and producing valuable syngas feedstocks.

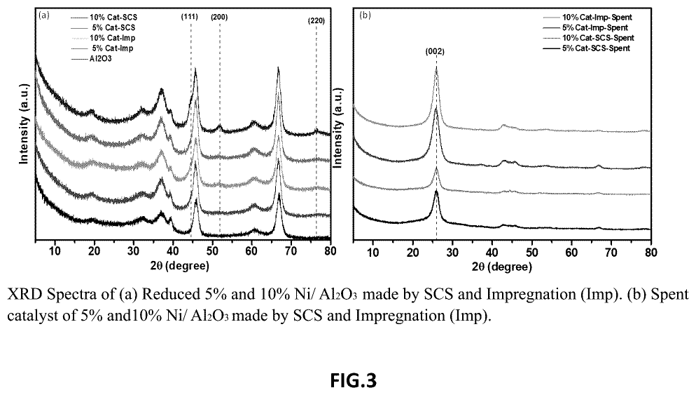

Moreover, FIGS. 3 to 5 show the x-ray diffraction (XRD), temperature program reduction (TPR), and Raman analysis of the disclosed technology. It should be noted that the carbon formation can proceed via tip growth or base growth mechanism. Also notable, the catalyst is able to do the gasification successfully with the cracking reaction in a stable manner. In base growth, the growth starts at the base of the catalyst particle, while in tip growth, the growth starts at the tip. The specific growth mode can be influenced by various factors, including the choice of catalyst, growth temperature, carbon source, and reaction time. Understanding these growth modes is essential for the controlled synthesis and tailoring of carbon nanostructures with specific properties for various applications. These growth mechanisms result in different structures and properties of carbons as Carbon Nanofibers (CNFs) or carbon nanotubes (CNTs). Carbon nanotubes (CNTs) have a more ordered and graphitic structure, which makes them less reactive towards CO₂ gasification. CNFs typically have a more disordered and turbostratic structure, which can provide more active sites for chemical reactions. The presence of defects and disordered carbon arrangements in CNFs can increase the accessibility of CO₂ molecules to the carbon atoms, promoting the gasification process.

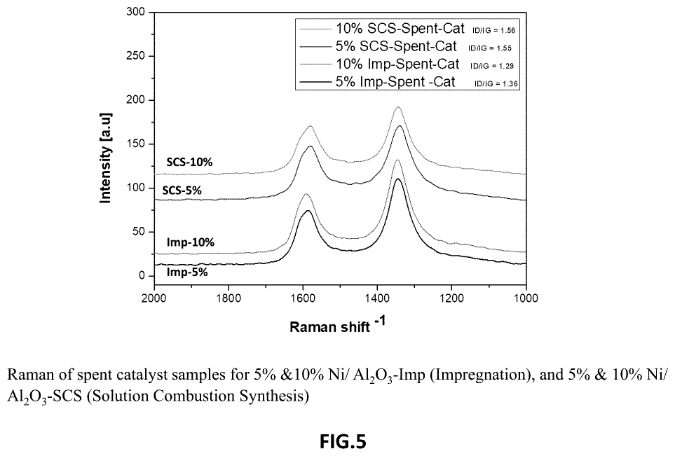

The graphitic order for carbon nanofibers formed by the methane decomposition is high if ID/IG ratio <1. However, when the ratio of ID/IG>1, the carbon nanofiber is amorphous. FIG. 5 shows how the ID/IG is much larger than 1 for the catalyst prepared by Solution Combustion Synthesis (SCS) compared to impregnation which is the preferred for the gasification reaction. This is also supported by the x-ray diffraction (XRD) results in FIG. 3, which show larger crystallinity and larger crystals for the carbon formed in the impregnation part compared to SCS.

Carbon nanofibers (CNFs) and carbon nanotubes (CNTs) can react with CO₂ to some extent even without metal doping or catalyst incorporation. However, the presence of catalysts or dopants can significantly enhance their CO₂ gasification reactivity. As carbon materials, they can interact with CO₂, and gasification reactions can occur spontaneously, especially at high temperatures. But a dopant with metal, for example Ni, can increase the reactivity of CNFs and CNTs towards CO₂. These dopants act as catalysts that facilitate the gasification reactions and lower the activation energy.

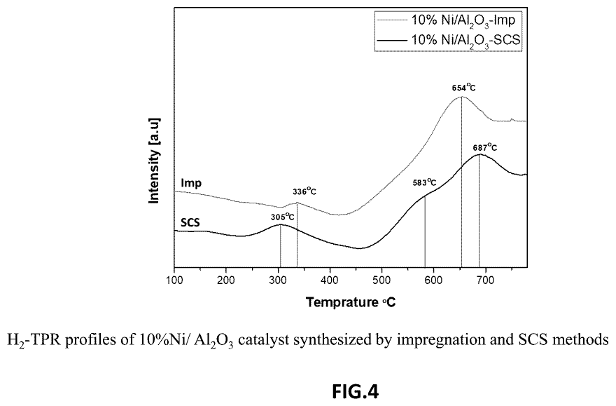

The Solution Combustion Synthesis (SCS) method can provide a substantial catalyst-metal support interaction and create catalysts with good activity, stability, and surface area, the level of control over the metal-support interaction may be higher with Impregnation. Solution Combustion can produce catalysts with a relatively uniform dispersion of metal oxides on the support. This homogeneous distribution can contribute to a higher degree of metal-support interaction compared to other synthesis methods. The SCS method is a one-pot synthesis method in which the metal is deposited on the catalyst support and is exposed to a high peak temperature during the combustion reaction. This high-temperature peak is essential to influence the metal support interaction which is the key to decide if the carbon growth mechanism is tip or base types. The metal-support interaction can stabilize the metal active sites on the catalyst surface. This stabilization helps maintain the active sites in a more accessible and reactive state during the gasification process. Consequently, the catalyst exhibits higher gasification reactivity due to the availability of more active sites for CO₂ adsorption and reaction. Also, strong metal-support interaction can lead to better dispersion of the metal particles on the support material. Enhanced dispersion provides a higher surface area of metal active sites, leading to more efficient utilization of the metal catalyst and, in turn, improved CO₂ gasification reactivity. FIG. 4 shows that Ni catalyst prepared by SCS has a different TPR profile than that prepared by impregnation. The metal support interaction in FIG. 4 is larger than that prepared by impregnation. Alternative to SCS, impregnation and other conventional methods, which can produce similar catalyst properties and specifications will achieve same promising results. Also, promoters can be added to enhance the catalyst performance further by adding less than 1% of noble metals, and or CaO, MgO, FeO/Fe2O3, and CeO up to 5 wt %, or rare metals as indium up to 1 wt % %.

The combination of the catalyst composition, specifications, and preparation method in this disclosure results in a cracking-gasification catalyst that has long-term stability and high productivity for many repeated cycles and allows reactions to proceed at a similar operating window simplifying the process design, operation, and economics.

The disclosed technology consumes Carbon Dioxide (CO₂), produces a valuable intermediate which is Carbon Monoxide (CO) that can be used in many other industries, and third, it avoids dealing with solid carbon as the de-facto by-product with Hydrogen (H₂). Thus, no need to limit this process to solid carbon.

Using the catalyst in the disclosed technology reduces the required operating high temperature needed by the methane decomposition to be in the range of 500° to 700° C. Although many methods are available that could be used to prepare catalysts for this process, it is identified that the catalyst proposed in the disclosed technology, Ni—Al₂O₃ catalyst with or without promotors, as prepared by solution combustion can achieve all of the unique features (metal particle size and distribution, support surface area and pore structure, metal support interaction) required to make the catalyst as ideal for this process. That is to have long-term stability, high productivity, and optimal operating window.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A metal-supported catalyst comprising nickel (Ni) nanoparticles supported on an alumina support material.

2. The metal-supported catalyst of claim 1, wherein the nickel nanoparticles range from 10 nm to 100 nm.

3. The metal-supported catalyst of claim 1, wherein the alumina support material has a surface area ranging from 80 m2/g to 200 m2/g.

4. The metal-supported catalyst of claim 1, wherein the alumina support is Al₂O₃.

5. The metal-supported catalyst of claim 1, wherein the nickle content is between 1 to 25 wt %.

6. The metal-supported catalyst of claim 1, wherein promotors can be added to the catalyst, and wherein the promotors are noble metals with rare metals up to 1 wt %, or CaO, MgO, FeO/Fe2O3, and CeO up to 5 wt %.

7. The metal-supported catalyst of claim 1, wherein the metal-supported catalyst is prepared using a solution combustion synthesis (SCS) method.

8. A process of producing a metal-supported catalyst, comprising:
preparing an alumina support material; and
impregnating the alumina support material with nickel (Ni) nanoparticles.

9. The process of claim 8, wherein the alumina support material has a surface area ranging from 80 m2/g to 200 m2/g.

10. The process of claim 8, wherein the nickel nanoparticles range from 10 nm to 100 nm.

11. The process of claim 8, wherein the nickle content is between 1 to 25 wt %.

12. The process of claim 8, wherein promotors can be added to the catalyst, and wherein the promotors are noble metals with rare metals up to 1 wt %, or CaO, MgO, FeO/Fe2O3, and CeO up to 5 wt %.

13. The process of claim 8, wherein the impregnation comprises using solution combustion synthesis (SCS) with or without fuel for combustion.

14. The process of claim 8, wherein the alumina support is Al₂O₃.

15. A process of converting natural gas and carbon dioxide into hydrogen and carbon monoxide comprising utilizing a metal-supported catalyst including nickel (Ni) nanoparticles supported on an alumina support material.

16. The process of claim 15, wherein the nickel nanoparticles range from 10 nm to 100 nm.

17. The process of claim 15, wherein the alumina support material has a surface area ranging from 80 m2/g to 200 m2/g.

18. The process of claim 15, wherein the alumina support is Al₂O₃.

19. The process of claim 15, wherein process takes place in a cyclic reactor, and wherein the cyclic reactor has a first mode of operation and a second mode of operation.

20. The process of claim 19, wherein the cyclic reactor comprises a first feed and a second feed, wherein the first feed is configured to receive one of CH₄ or a CH₄-rich source, and wherein the second feed is configured to receive one of CO₂ or a CO₂-rich source.

21. The process of claim 20, wherein in the first mode of operation the cyclic reactor receives one of the CH₄ or CH₄-rich source via the first feed, and wherein the cyclic reactor uses the metal-supported catalyst including nickel (Ni) nanoparticles supported on an alumina support material to convert the CH₄ or CH₄-rich source to hydrogen (H₂) and solid carbon, wherein the solid carbon is deposited on the metal-supported catalyst including nickel (Ni) nanoparticles supported on an alumina support material.

22. The process of claim 20, wherein in the second mode of operation the cyclic reactor receives, in a reactor zone, one of the CO₂ or a CO₂-rich source via the second feed, and wherein the solid carbon deposited on the metal-supported catalyst including nickel (Ni) nanoparticles supported on an alumina support material during the first mode of operation reacts with the CO₂ or CO₂-rich source in the reactor zone to form CO, CO₂, or a mixture thereof.

23. The process of claim 22, wherein an effluent from the cyclic reactor exits the cyclic reactor during the second mode of operation.

24. The process of claim 23, wherein the effluent contains CO, CO₂, and unreacted CO₂ or CO₂-rich source from the second feed.
